(19) United States
(12) Patent Application Publication
(10) Pub. No.: US 2006/0034325 A1
(43) Pub. Date: Feb. 16, 2006

(54) System and method for mapping SONET management data to the payload of a SONET STS-1 frame

(75) Inventors: Edward Walter, Boerne, TX (US); Steven M. Wollmershauser, San Antonio, TX (US); Jorey M. Pascasio JR., San Antonio, TX (US)

Correspondence Address: TOLER & LARSON & ABEL L.L.P., 5000 PLAZA ON THE LAKE STE 265, AUSTIN, TX, 78746, US

(73) Assignee: SBC Knowledge Ventures, L.P.

(21) Appl. No.: 10/915,261

(22) Filed: Aug. 10, 2004

(51) Int. Cl. H04L 12/28

(52) U.S. Cl. 370/466

(57) ABSTRACT

A method of deploying a synchronous optical network (SONET) terminal is provided. The SONET terminal includes a management interface and an Ethernet port. A layer 2/3 data switch is connected to the management interface and the Ethernet port. Data associated with the SONET terminal is received at the layer 2/3 data switch. Further, the management data from the SONET terminal is converted from STS-1 data to DSx data at the layer 2/3 data switch. In a particular embodiment, the DSx data is routed to a DS1 channel within the SONET terminal. Also, the converted management data is transported over a data network as part of a SONET signal payload.

### FIELD OF THE DISCLOSURE

The present disclosure relates generally to the management of synchronous optical network (SONET) devices.

### BACKGROUND

Synchronous Optical Network (SONET) is a set of international standards for fiber-based systems. The standards set forth by SONET define optical carrier (OC) levels and the electrically equivalent synchronous transport signals (STS) for the fiber-optic based transmission hierarchy. For example, an OC-1 is equivalent to an STS-1 and provides a data transmission rate of 51.84 Mega bits per second (Mbps). Higher line rates are integer multiples of the base rate of 51.84 Mbps. In other words, an OC-3, and the corresponding STS-3, has a data transmission rate equal to 3 times 51.84 Mbps or 155.52 Mbps. Under the SONET standard, OC-3, OC-12, OC-48, and OC-192 are widely supported fiber-optic rates. However, other rates exist, e.g., OC-9, OC-18, OC-24, and OC-36.

A basic STS-1 frame includes ninety columns and nine rows of 8-bit bytes. The first three columns make up the transport overhead. Within the overhead, many of the bytes are blocked by the Regional Bell Operating Companies (RBOCs). For example, the Data Communications Channel (DCC) in the overhead is blocked by most RBOCs. An RBOC typically blocks the DCC because the RBOC can use the DCC to manage internal optical network devices. Accordingly, to prevent a customer from inadvertently or intentionally making changes to telephone company switches and routers the DCC is blocked.

The DCC is the channel that carries switch management data, e.g., configuration information, remote access, and remote monitoring of alarms. If the DCC is blocked by an RBOC, a customer is prevented from using the DCC to manage their own optical network gear, which, in most cases, is connected to the local area network (LAN) side of the RBOC equipment or is installed in place of the RBOC network equipment. The current solution for this problem is to install a separate integrated services digital network (ISDN) line, or equivalent, to each location, and designate that ISDN line as the management link. The costs associated with this solution can become expensive when a customer has multiple locations and must management multiple pieces of network equipment.

Accordingly, there is a need for an improved system and method for managing SONET equipment.

### BRIEF DESCRIPTION OF THE DRAWINGS

The present invention is pointed out with particularity in the appended claims. However, other features are described in the following detailed description in conjunction with the accompanying drawings in which:

FIG. 1 is a diagram of an exemplary STS-1 frame;

FIG. 2 is a block diagram that is representative of an optical network system;

FIG. 3 is a flow chart to illustrate a method for deploying a SONET terminal; and

FIG. 4 is a flow chart to illustrate an alternative method for deploying a SONET terminal.

### DETAILED DESCRIPTION OF THE DRAWINGS

A method of deploying a synchronous optical network (SONET) terminal is provided. The SONET terminal includes a management interface and an Ethernet port. A layer 2/3 data switch is connected to the management interface and the Ethernet port. Data associated with the SONET terminal is received at the layer 2/3 data switch. Further, the management data from the SONET terminal is converted from STS-1 data to DSx data at the layer 2/3 data switch. In a particular embodiment, the DSx data is routed to a DS1 channel within the SONET terminal. Also, the converted management data is transported over a data network as part of a SONET signal payload.

In another embodiment, a method of deploying a SONET terminal is provided. The SONET terminal includes a management interface. The management interface is connected to a downstream Ethernet data switch. In turn, the Ethernet data switch is connected to an Ethernet port at the SONET terminal. Further, management data is transported to the Ethernet data switch. The management data is mapped to the payload portion of a SONET STS-1 data signal.

In yet another embodiment, a method for managing a SONET terminal is provided. During execution of the method, management data is obtained from the SONET terminal. The management data for the SONET terminal is mapped to a payload portion of a SONET STS-1 data signal.

In still another embodiment, a method for managing a SONET terminal is provided wherein management data is retrieved from a SONET terminal. The management data is converted to DSx data format for communication over a DS1 communication channel.

In yet still another embodiment, a method for managing a SONET terminal is provided. Management data is obtained from a SONET terminal. The management data is assigned the same Internet protocol address as a management interface on the SONET terminal. Further, the management data is mapped into an STS-1 data signal payload.

In another embodiment, a network system includes a first SONET terminal and a second SONET terminal. Each SONET terminal includes a management interface and an Ethernet port. Also, the second SONET terminal is connected to the first terminal to establish an optical ring. The network system further includes a management router that is connected to the second SONET terminal. A management service provider is connected to management router via an Internet connection. Additionally, a switch is connected to the first SONET terminal. The switch is connected to the management interface and the Ethernet port of the first SONET terminal. Further, the switch receives SONET management data and converts the SONET management data from STS-1 data to DSx data.

In still another embodiment, a network system includes a first SONET terminal and a second SONET terminal. Each SONET terminal has a management interface and an Ethernet port. The second SONET terminal is connected to the first terminal to establish an optical ring. A management router is connected to the second SONET terminal. Also, a management service provider is connected to a management router via an Internet connection. An Ethernet switch is connected to the first SONET terminal. Specifically, the Ethernet switch is connected to the management interface of the first SONET terminal downstream from the management interface. Moreover, the Ethernet switch is connected to the Ethernet port of the first SONET terminal. In this embodiment, management data from the first SONET terminal is mapped into the payload of an STS-1 signal.

In yet another embodiment, a network system includes a first SONET terminal and a second SONET terminal. Each SONET terminal has a management interface and an Ethernet port. Also, the second SONET terminal is connected to the first terminal to establish an optical ring. A management router is connected to the second SONET terminal. Further, a management service provider is connected management router via an Internet connection. The management service provider manages the first SONET terminal and the second SONET terminal via a distributed network.

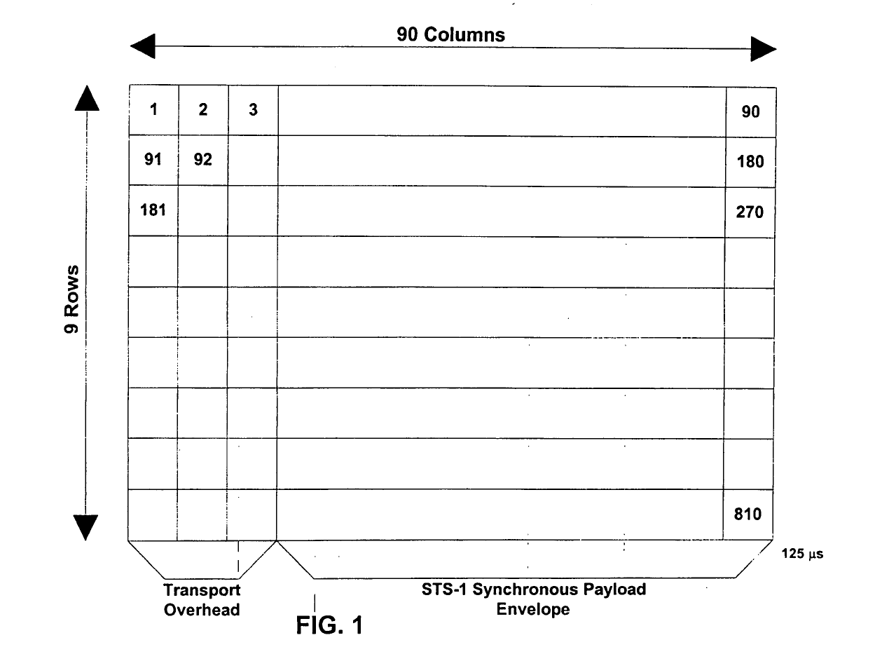

FIG. 1 shows a basic STS-1 frame that is generally designated 100. As shown, the STS-1 frame 10 includes ninety columns and nine rows of 8-bit bytes 102. The first three columns make up the transport overhead 104. The remaining columns make up the synchronous payload envelope 106. The synchronous payload envelope can be divided into two parts: the STS path overhead and the payload. The payload is the revenue-producing traffic that is transported and routed over a SONET network. Typically, an STS-1 signal is transmitted byte-by-byte beginning with byte one and scanning left to right from row one to row nine. The entire STS-1 frame 100 is transmitted in 125 microseconds.

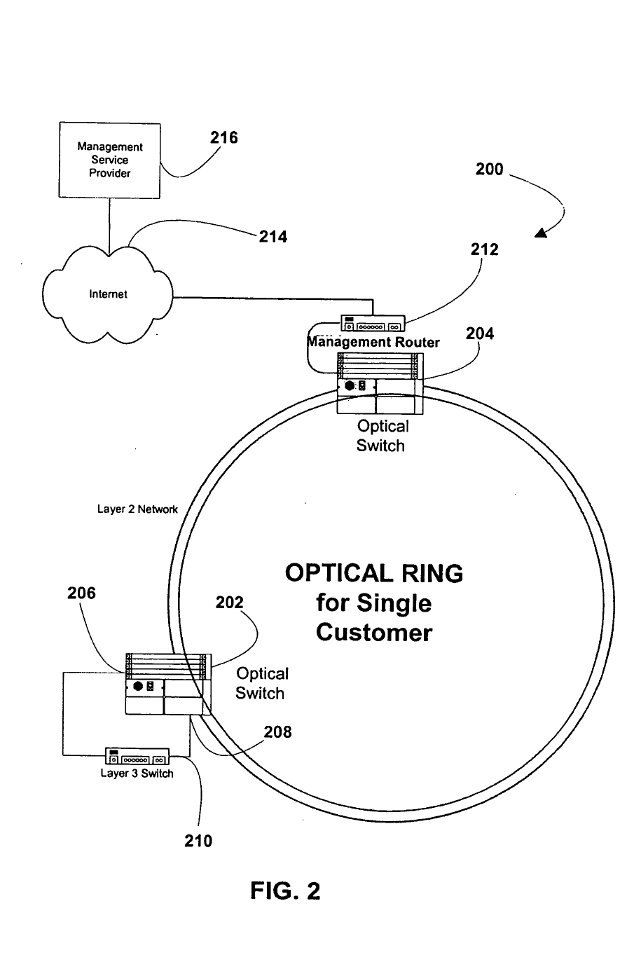

Referring to FIG. 2, an optical network system is shown 200. As shown, the system 200 includes a first SONET terminal 202, e.g., an optical switch, that is connected to a second SONET terminal 204, e.g., an optical switch. FIG. 2 illustrates that the SONET terminals 202, 204 can be connected in a ring configuration.

In a particular embodiment, each of the SONET terminals 202, 204 includes one or more management interfaces 206, e.g., a 10BaseT Ethernet interface or an RS-232 interface, that can be used to access management data at the SONET terminal 202, 204. FIG. 2 further shows that each SONET terminal 202, 204 can also include an Ethernet port 208, e.g., a 10/100BaseT or VT 1.5 port, that is located on the line side of each SONET terminal 202, 204.

In an illustrative embodiment, a switch 210, e.g., a layer 2/3 mini-switch, can be connected to the management interface 206 of the first SONET terminal 202 and the Ethernet port 208 of the first SONET terminal 202 in order to provide accessibility to management data on the first SONET terminal 202 and thus, provide a way to manage the first SONET terminal 202 without using the DCC of the STS-1 frame.

FIG. 2 further shows a management router 212 that can be connected to the second SONET terminal 204. In a particular embodiment, the management router 212 can be connected to the Internet 214 which, in turn, can be connected to a management service provider 216. The SONET management data can be transported over the SONET network system 200 as part of the SONET payload and as such, the management data be transported to the management service provider 216 and used to manage the equipment within the SONET network system 200.

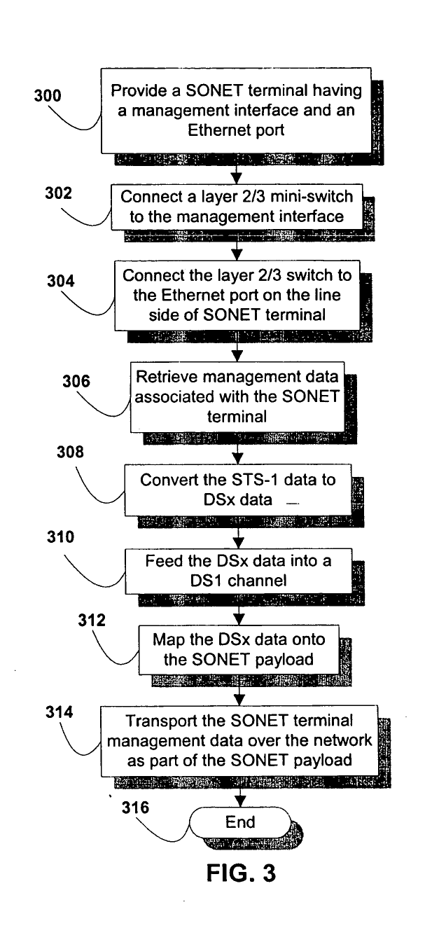

Referring now to FIG. 3, a method for deploying a SONET terminal is shown and commences at block 300. At block 300, a SONET terminal is provided and includes a management interface and an Ethernet port. Moving to block 302, a layer 2/3 mini-switch is connected to the management interface. The layer 2/3 mini-switch is connected to the Ethernet port of the SONET terminal at block 304. At block 306, management data associated with the SONET terminal is retrieved from the SONET terminal.

Proceeding to block 308, the SONET terminal management data is converted from STS-1 frame data into DSx format, e.g., by the layer 2/3 mini switch. At block 310, the DSx data is fed into a DS1 channel of the SONET terminal. Thereafter, at block 312, the DSx data is mapped onto the payload portion of the SONET STS-1 signal. Moving to block 314, the SONET terminal management data is transported on the network as part of the SONET payload. The logic ends at state 316.

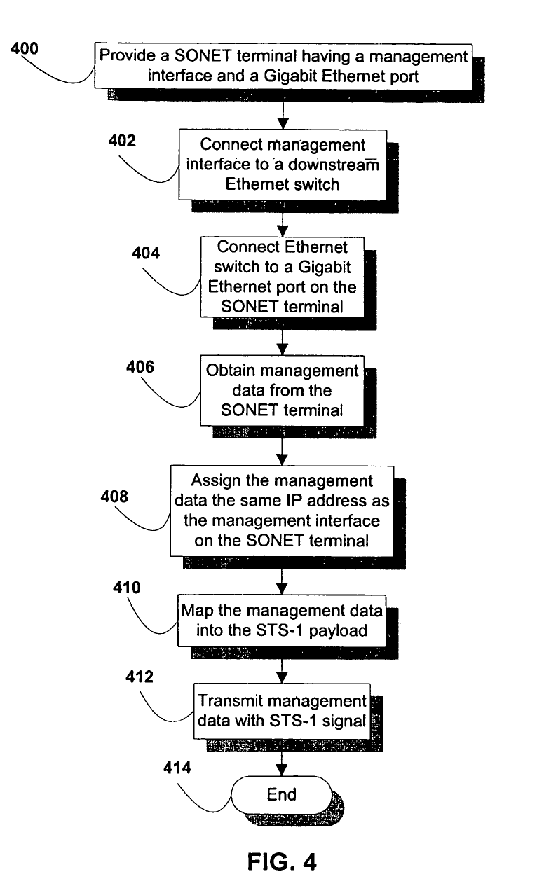

FIG. 4 shows an alternative method for mapping SONET management data to the payload of an STS-1 frame. Beginning at block 400, a SONET terminal is provided and includes a management interface and a Gigabit Ethernet port. In a particular embodiment, the SONET terminal is an optical switch. At block 402, the management interface of the SONET terminal is connected to a downstream Ethernet switch. Moving to block 404, the Ethernet switch is connected to a Gigabit Ethernet port at the SONET terminal. Next, at block 406, the management data for the SONET terminal is obtained. In an illustrative embodiment, the management data for the SONET terminal includes configuration information for the SONET terminal. Also, the management data provides remote access to the SONET terminal and remote monitoring of one or more alarms at the SONET terminal. At block 408, the management data is assigned the same Internet Protocol (IP) address as the management interface of the SONET terminal. As such, a unique IP address for each SONET terminal is available to a network management system, e.g., OpenView from Hewlett-Packard, Network Node Manager, or Micromuse.

Continuing to block 410, the management data is mapped into the payload of the STS-1 frame. Thereafter, at block 412, the STS-1 frame signal is mapped to an Ethernet port on an Ethernet switch downstream from the SONET terminal. The logic then ends at state 414.

With the configuration of structure described above, the system and method for mapping SONET management data to the payload of a SONET STS-1 frame provides capability to drop encapsulated management traffic anywhere within a SONET network. The data can be provided to a management service provider which can manage multiple SONET terminals within a particular client ring without requiring the use of an additional ISDN line for every piece of managed equipment in the client's SONET network. Thus, the disclosed system and method provides improved management of SONET equipment at a reduced cost.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method of deploying a synchronous optical network (SONET) terminal having a management interface and an Ethernet port, the method comprising:
connecting a layer 2/3 data switch to the management interface and the Ethernet port;
receiving management data associated with the SONET terminal at the layer 2/3 data switch; and
converting the management data from STS-1 data to DSx data at the layer 2/3 data switch.

2. The method of claim 1, further comprising:
routing the DSx data to a DS1 channel within the SONET terminal.

3. The method of claim 2, further comprising:
transporting the converted management data over a data network as part of a SONET signal payload.

4. The method of claim 3, further comprising:
retrieving the management data from the SONET signal payload at a location remote to the SONET terminal.

5. The method of claim 4, further comprising:
managing the SONET terminal from the location remote to the SONET terminal.

6. A method of deploying a synchronous optical network (SONET) terminal having a management interface, the method comprising:
connecting the management interface to a downstream Ethernet data switch;
connecting the Ethernet data switch to an Ethernet port at the SONET terminal;
transmitting management data to a Ethernet data switch; and
mapping management data to the payload portion of a SONET STS-1 data signal.

7. The method of claim 6, further comprising:
assigning the management data the same Internet protocol address as the management interface.

8. The method of claim 7, further comprising:
transmitting the management data to a management service provider with the SONET STS-1 data signal.

9. The method of claim 8, further comprising:
extracting the management data from the SONET STS-1 data signal.

10. The method of claim 9, further comprising:
using the SONET STS-1 data signal for remote management of the SONET terminal.

11. The method of claim 6, wherein the management data includes at least one of the following: configuration information for the SONET terminal, remote access information for the SONET terminal, and remote monitoring information for one or more alarms at the SONET terminal.

12. A method for managing a synchronous optical network (SONET) terminal, the method comprising:
obtaining management data from the SONET terminal; and
mapping the management data for the SONET terminal to a payload portion of a SONET STS-1 data signal.

13. The method of claim 12, further comprising:
assigning the management data the same Internet protocol address as a management interface on the SONET terminal.

14. The method of claim 13, further comprising:
mapping the SONET STS-1 data signal to an Ethernet port on an Ethernet data switch.

15. The method of claim 14, further comprising:
transmitting the SONET STS-1 data signal to a remote management device.

16. The method of claim 15, further comprising:
extracting the management data from the SONET STS-1 data signal at the remote management device.

17. The method of claim 16, further comprising:
managing the SONET terminal using the SONET STS-1 data signal.

18. The method of claim 12, wherein the management data includes at least one of the following: configuration information for the SONET terminal, remote access information for the SONET terminal, and remote monitoring information for one or more alarms at the SONET terminal.

19. A method for managing a synchronous optical network (SONET) terminal, the method comprising:
retrieving management data from a SONET terminal; and
converting the management data to DSx data format for communication over a DS1 communication channel.

20. The method of claim 19, further comprising:
supplying the converted management data to a DS1 communication channel.

21. The method of claim 20, further comprising:
transmitting the converted management data over a distributed data network to a remote system as part of a SONET data signal payload.

22. The method of claim 20, further comprising:
extracting the management data from the SONET data signal payload at the remote system.

23. The method of claim 22, further comprising:
remotely managing the SONET terminal at least partially based on the management data within the SONET data signal payload.

24. The method of claim 19, wherein the management data includes at least one of the following: configuration information for the SONET terminal, remote access information for the SONET terminal, and remote monitoring information for one or more alarms at the SONET terminal.

25. A method for managing a synchronous optical network (SONET) terminal, the method comprising:
receiving a SONET data signal over a distributed data network from the SONET terminal;
extracting management data from a payload of the SONET data signal;
managing the SONET terminal at least partially based on the management data within the payload of the SONET data signal.

26. The method of claim 25, wherein the SONET data signal is received at a management service provider.

27. The method of claim 26, wherein the management data is assigned the same Internet protocol address as a management interface on the SONET terminal.

28. The method of claim 27, wherein the management data includes at least one of the following: configuration information for the SONET terminal, remote access information for the SONET terminal, and remote monitoring information for one or more alarms at the SONET terminal.

29. A network system, comprising:
a first synchronous optical network (SONET) terminal having a management interface and an Ethernet port;
a second SONET terminal having a management interface and an Ethernet port, the second SONET terminal being connected to the first terminal to establish an optical ring;
a management router connect to the second SONET terminal;
a management service provider connected management router via an Internet connection; and
a switch connected to the first SONET terminal, the switch being connected to the management interface and the Ethernet port of the first SONET terminal, the switch receiving SONET management data and converting the SONET management data from STS-1 data to DSx data.

30. The system of claim 29, wherein the DSx data is communicated to a DS1 channel within the first SONET terminal.

31. The system of claim 30, wherein the DSx data is mapped onto the payload of an STS-1 data signal.

32. The system of claim 31, wherein the SONET management data is transported over the SONET network as part of the SONET payload.

33. The system of claim 29, wherein the switch is a layer 2/3 mini-switch.

34. The system of claim 29, wherein the management data includes at least one of the following: configuration information for the SONET terminal, remote access information for the SONET terminal, and remote monitoring information for one or more alarms at the SONET terminal.

35. A network system, comprising:
a first synchronous optical network (SONET) terminal having a management interface and an Ethernet port;
a second SONET terminal having a management interface and an Ethernet port, the second SONET terminal being connected to the first terminal to establish an optical ring;
a management router connect to the second SONET terminal;
a management service provider connected management router via an Internet connection; and
a Ethernet switch connected to the first SONET terminal, the Ethernet switch being connected to the management interface of the first SONET terminal downstream from the management interface, the Ethernet switch being connected to the Ethernet port of the first SONET terminal, wherein management data from the first SONET terminal is mapped into the payload of an STS-1 signal.

36. The system of claim 35, wherein the management data is assigned the same IP address as the management interface of the first SONET terminal.

37. The system of claim 36, wherein the management data includes at least one of the following: configuration information for the SONET terminal, remote access information for the SONET terminal, and remote monitoring information for one or more alarms at the SONET terminal.

38. A network system, comprising:
a first synchronous optical network (SONET) terminal having a management interface and an Ethernet port;
a second SONET terminal having a management interface and an Ethernet port, the second SONET terminal being connected to the first terminal to establish an optical ring;
a management router connect to the second SONET terminal; and
a management service provider connected management router via an Internet connection, wherein the management service provider manages the first SONET terminal and the second SONET terminal via a distributed network.

39. The system of claim 38, wherein at least one of the first SONET terminal and the second SONET terminal is an optical switch.

40. The method of claim 38, wherein the management data includes at least one of the following: configuration information for the SONET terminal; remote access information for the SONET terminal; and remote monitoring information for one or more alarms at the SONET terminal.
